(19) United States
(12) Patent Application Publication
(10) Pub. No.: US 2022/0046862 A1
(43) Pub. Date: Feb. 17, 2022

(54) Belt Drive for a Weed Seed Destructor of a Combine Harvester

(71) Applicant: Dean Mayerle, Saskatoon (CA)

(72) Inventor: Dean Mayerle, Saskatoon (CA)

(21) Appl. No.: 17/386,885

(22) Filed: Jul. 28, 2021

Related U.S. Application Data
(60) Provisional application No. 63/065,609, filed on Aug. 14, 2020.

(51) Int. Cl. A01F 29/04; A01D 41/12; A01F 12/40; A01F 12/56; A01F 29/14

(52) U.S. Cl. CPC A01F 29/04; A01D 41/1243; A01F 29/14; A01F 12/56; A01F 12/40

(57) ABSTRACT

Weed seeds are destroyed in the chaff from a combine harvester by repeated high speed impacts caused by a rotor mounted in one of a pair of side by side housings which accelerate the discarded seeds in a direction centrifugally away from the rotor onto a stator including angularly adjustable stator surfaces around the axis. The weed seed destructor is driven with a straw management system from an output shaft of the combine harvester so that the full power required for both passes through a belt which includes more than four longitudinally extending v-belt ribs and reinforcing cords located in a base band above the ribs at uniformly spaced positions across the width of the belt so that a replacement drive pulley on the output shaft has a width not significantly greater than a conventional output pulley which it replaces.

This application claims the benefit under 35 USC 119 ( ) of Provisional application 63/065,609 filed Aug. 14, 2020, the disclosure of which is incorporated herein by reference.

This invention relates to a weed seed destructor which can be attached to a combine harvester so that weed seeds in the discharged chaff can be devitalized before being spread onto the ground and particularly to a drive arrangement which provides a mechanical drive from a power take off shaft of the combine harvester to the destructor.

### BACKGROUND OF THE INVENTION

Combine harvesters typically have many v-belt drives to transfer power from the engine to various components on the harvester. The most demanding drive may be the residue management driveline due to its requirement to process crop residue that may easily be threshed but is not yet fully dry or fit for processing. The residue management system driveline typically is driven from the main engine gearcase and can take over 50% of the engine's power capacity. The main engine gearcase typically has a single power takeoff sheave that provides drive to the residue management system.

In recent years the combine's engine capacities have increased significantly, with some machines now fitted with 790 HP engines. With larger engines the loads for processing crop residue have increased significantly. Typically, the combine's residue management systems include a straw chopper and may include a powered tailboard for spreading residue in inclement conditions. Most recently weed seed destruction systems have been added to the residue management systems, increasing the power transfer requirement of the residue management drivelines by another 30%.

Combine harvester drivelines have been designed for specific loads and are typically optimized to the worst cases recorded during the combine's development. The belts, sheaves and bearings in these harvesters are designed for a certain life at the worst-case load duty cycles. Bearings in the drive train are designed based on the belt loading due to tensioning, the over hung load and belt power transmitted during operation. In lower yielding crop areas of the world, aftermarket designers are able to utilize the extra capacity in the drives due to lower crop yields and thus lower system loads. However, when adding components in high yielding, tough crop conditions that additional capacity is not available and significant cost is incurred to redesign and increase the capacity of the drives.

Typically, the drives found in combine harvesters utilize banded v-belts as this simple v-belt provides protection against high spike loads that are typical in harvesters, and works very well in the dirty conditions found in field operation. Engineers skilled in power transmission design typically increase the number of ribs on a belt, increase the sheave diameter, or increase cross sectional area of the v-belt to reduce belt loads or increase the life of a belt. This often has a ripple effect as the increased size and weight of the sheaves increases the overhung load on the bearings, requiring increased bearings and with larger cross-sectional belt profiles more heat is generated in belt flex, reducing belt life and performance.

There are 2 major categories of belts: v-belts and synchronous or timing belts. V-belts transmit power by friction and utilize the wedge principle to increase sidewall pressure and frictional force. Synchronous or timing belts transmit power by direct engagement of belt teeth with a sprocket.

Synchronous belts are the most efficient belt available and the most power dense belt (meaning the cord density is arranged as tightly as possible), however they do not work well with misaligned sheaves, debris or shock loads. These belts cannot slip to protect the drive or the object they are powering and can only be designed with a fixed or locked center. Synchronous belts are typically chosen if shafts must be synchronized, efficiency is extremely important, or the power is so high in limited space that a v-belt cannot transfer the load.

V-belts on the other hand operate well in misaligned conditions, are more forgiving to debris, and are good at slipping to protect drives that operate with large shock loads, such as straw choppers. They can be used with a spring-loaded constant tension idler and run relatively quietly. They, however, do not have good cord or power density and operate at lower efficiency than a synchronous belt.

V-belts are further classified into single v-belts, banded v-belts and v-rib belts. Single v-belts are very robust and are used in many applications due to their lower cost. Banded v-belts prevent rollover from vibration, are easier to install than multiple singles, and are best at controlling belt deflection and remaining in sheave grooves on drives with high spike loads.

Due to operating limitations on all other belt types and profiles the banded v-belt is used on all combine harvesters today. It is the only type of belt used on demanding residue management systems.

V rib belts are manufactured by initially assembling the cords in the required pattern which are then wrapped around a spool to be held in place. The filler material typically some type of rubber is then it is poured to form a cast band having a full thickness of the band up to the top of the intended ribs. The ribs may be formed by the profiles of the spools or the cast band can be machined to grind the V grooves between the ribs to form the ribs. The machining is carried out down to the base of the grooves spaced from a rear face of the cast band leaving a base band portion connecting the ribs together

### SUMMARY OF THE INVENTION

According to one aspect of the invention there is provided a combine harvester comprising:

a separation system for separating material from harvested crop including a first material comprising straw and a second material comprising chaff;

a mechanical drive output shaft having an output pulley thereon;

a weed seed destructor section for receiving at least some of the material from the separating device;

the weed seed destructor section having at least one input drive shaft having an input pulley thereon

a mechanical drive transfer arrangement connecting the input drive pulley to the mechanical drive output pulley;

the mechanical drive transfer arrangement including at least one continuous drive belt;

wherein said at least one continuous drive belt includes across its width a plurality of longitudinally extending v-belt ribs;

wherein said at least one continuous drive belt includes one or more cords forming longitudinally extending cord lengths which extend continuously along the continuous drive belt;

and wherein the longitudinally extending cord lengths are located at uniformly spaced positions across the width of the belt.

In some cases the cords can be formed as individual cords each defining one cord length wrapped wholly around the belt in one continuous loop. In other cases the belts have only one cord wrapped continuously in a helical wrap so that the single cord forms all of the cord lengths. The helical wrap is applied at a pitch so as to place the cord lengths in the backing at a uniform pitch across the width of the belt. Thus the one cord is wound around the belt. Other belts have one cord per rib (because the cord is in the rib) and thus a 3 rib belt has 3 cords. The helical wrapping provides an efficiency and extra load carrying capacity which comes from the fact that engineers discount one half of the wrap on each side. Only once the cord has been wrapped around the belt one half of the circumference will it start to pull load.

In a second aspect, the v-belt ribs are integral at a base with a base band of the belt extending across the full width of the belt with each rib having two side walls converging from the base to a top wall spaced from the base band where all of the reinforcing cords are arranged in a single row across the base band.

In a third aspect, the v-belt ribs are cut to a base band of the belt extending across the full width of the belt with each rib having two side walls converging from the base to a top wall spaced from the base band where all of the reinforcing cords are arranged in a single row across the base band.

According to a further aspect of the invention there is provided a method of driving components of a combine harvester where the combine harvester comprises:

a separation system for separating from harvested crop a first material comprising straw and a second material comprising chaff;

a mechanical drive output shaft;

a straw management section for receiving the first material;

the straw management section having at least one input drive shaft having an input pulley thereon;

the method comprising:

mounting on the combine harvester a weed seed destructor section arranged to receive the second material, said weed seed destructor section comprising:
at least one destructor rotor arrangement for rotation about an axis and including rotor surfaces thereon for engaging the second material and for accelerating the second material in a direction;
a stator arrangement mounted at a location along the direction and including a plurality of stator surfaces for engaging the weed seeds in the accelerated said second material to cause a plurality of impacts with the weed seeds;
the destructor rotor arrangement having an input drive member with an input pulley thereon;

providing on the combine harvester a mechanical drive transfer arrangement connecting the input drive pulley of the straw management section to the mechanical drive output pulley;

the mechanical drive transfer arrangement including at least one continuous drive belt;

providing an output pulley on the output shaft arranged for driving both the straw management section and the weed seed destructor section;

and providing a drive belt shaped to engage the output pulley which carries all of the power required to drive the weed seed destructor section and at least part of the straw management section;

wherein the continuous drive belt includes a plurality of longitudinally extending v-belt ribs;

wherein said at least one continuous drive belt includes one or more cords forming longitudinally extending cord lengths which extend continuously along the continuous drive belt;

wherein the longitudinally extending cord lengths are located at uniformly spaced positions across the width of the belt.

That is the present arrangement provides a construction of belt to carry the whole of the power required by the straw spreader or chopper and by the weed seed destructor where the belt to mount on an output pulley which can have a width closely matching or not significantly greater than that of the original pulley designed to carry much lower power.

In one preferred drive arrangement, the input pulley of the destructor rotor is driven by a belt from the input drive shaft of the straw management section preferably by a pulley at an end of the input drive shaft of the straw management section opposite to said input drive pulley thereof.

Preferably the belt has more than four and more preferably six v-belt ribs at spaced positions across its width.

Preferably the belt has a width of less than 3.0 inches and preferably less than 2.5 inches and preferably less than 2.3 inches.

Preferably the belt has a depth of less than 0.5 inches and preferably less than 0.4 inches and preferably of the order of 0.35 inches.

There are 8 different standard cross sections that are utilized worldwide. V-rib belts are not as common but are used in high power capacity requirements. Limitations include less misalignment and they require a cleaner environment than standard v-belts. V-rib belts are not as sensitive as synchronous belts, however they are much quieter, can carry the same loads, are infinitely adjustable in length, can maintain a slip functionality to protect the drive in a spike load situation and can be used with a constant tension idler. Advantages of a constant tension drive include ease of installation and tensioning, higher bearing life with reduced loads due to a reduced duty cycle, run quieter and provide belt slip.

The cords in the belt are the components that transfer power between the sheaves of the belt drive. The rubber surrounding the belt's cord serve to transfer the load from the cords to the sheaves. The larger the belt section, the larger the available space for the cords and the larger the rubbers surface area on the sheave to transmit the power from the cords to the sheave.

Increased loads are driving designers to larger v-belt profiles in order to carry enough cords to transmit the required amount of power, however the larger the v-belt profile the more heat is generated by the belt in bending.

In banded v-belts the cords are only carried in the individual belt profile, therefor a banded belt, that is best utilized for spike loads typical in residue management systems, are not optimized as they do not have cords positioned uniformly across the width of the banded belt.

Increase load capacity caused by the added weed seed destruction function has not been designed in residue management system drives; therefore additional space typically must be taken to expand drive capacity. Combine harvesters are very complex and have many optional pieces of equipment. Drivelines have limited space and may not have the space to expand the number of belt ribs or to increase sheave diameters. Thus, expansion of the belt profile or number of belt ribs often affects sheave size adding weight and increasing the overhung load requiring increased bearings and or structural change to the harvester.

The arrangement of the present invention may provide one or more of the following features and advantages:

Provide additional power transmission capacity without taking more space than the residue management drive currently operates in, while maintaining the driveline's protection/slip functionality of a v-belt, the capability to operate in dirty environments, and the spike load protection of banded v-belts.

Provide a more power dense belt; a belt with cords packed more tightly together and spread uniformly across the width of the belt, so that more power can be transmitted in the same space.

Provide additional power transmission capacity for the addition of seed destruction systems, with a belt in which there are cords positioned uniformly across the width of the belt, without significantly varying gaps between each individual cord, in the same space as the existing OEM residue management drives.

Provide additional power transmission capacity to the straw chopper, with a belt in which cords positioned uniformly across the width of the belt so that additional drive can be provided from the chopper rotor sheave to a seed destructor.

Provide additional power transmission capacity to the residue management system's jackshaft, with a belt in which cords are positioned uniformly across the width of the belt so that additional drive can be provided to a seed destructor.

Provide additional power transmission capacity to the straw chopper rotor, with a belt in which the cords are positioned uniformly across the width of the belt so that additional drives can be provided through the chopper rotor and from the opposite side of the chopper rotor.

Provide torque through the straw chopper rotor so that a drive can be driven from either side of the straw chopper rotor.

According to a further independent feature of the invention there is provided a combine harvester comprising:

a separation system for separating material from harvested crop including a first material comprising straw and a second material comprising chaff;

a mechanical drive output shaft having an output pulley thereon;

a straw management section for receiving the first material;

a seed destructor section for receiving the second material;

a first mechanical drive transfer arrangement connecting the mechanical drive output pulley to the straw management section to provide drive thereto;

the mechanical drive transfer arrangement including at least one drive belt arranged at a first side of the combine harvester;

wherein the seed destructor section is driven by a second mechanical drive transfer arrangement on a second side of the combine harvester opposite the first side.

Preferably the straw management section includes a shaft to transfer drive from the first side to the second side.

Preferably the straw management section comprises a straw chopper and wherein the shaft to transfer drive from the first side to the second side drives a rotor of the straw chopper.

This arrangement provides an improved drive construction which may provide advantages of reduced loads on the pulleys and belt.

It will be appreciated that the novel features herein relate to the construction of the straw management system and the weed seed destructor system and particularly the drive arrangements thereto. These features are expressed above as part of a combine harvester. However the construction may be supplied as a separate apparatus for mounting on a combine harvester so that the invention resides in the components themselves independently of the combine harvester.

### BRIEF DESCRIPTION OF THE DRAWINGS

One embodiment of the invention will now be described in conjunction with the accompanying drawings in which:

FIG. 1 is an isometric view of a combined apparatus for straw management and for destruction of weed seeds according to the present invention.

FIG. 2 is side elevational view of the combined apparatus including the straw chopper section and the weed seed destruction section of FIG. 1.

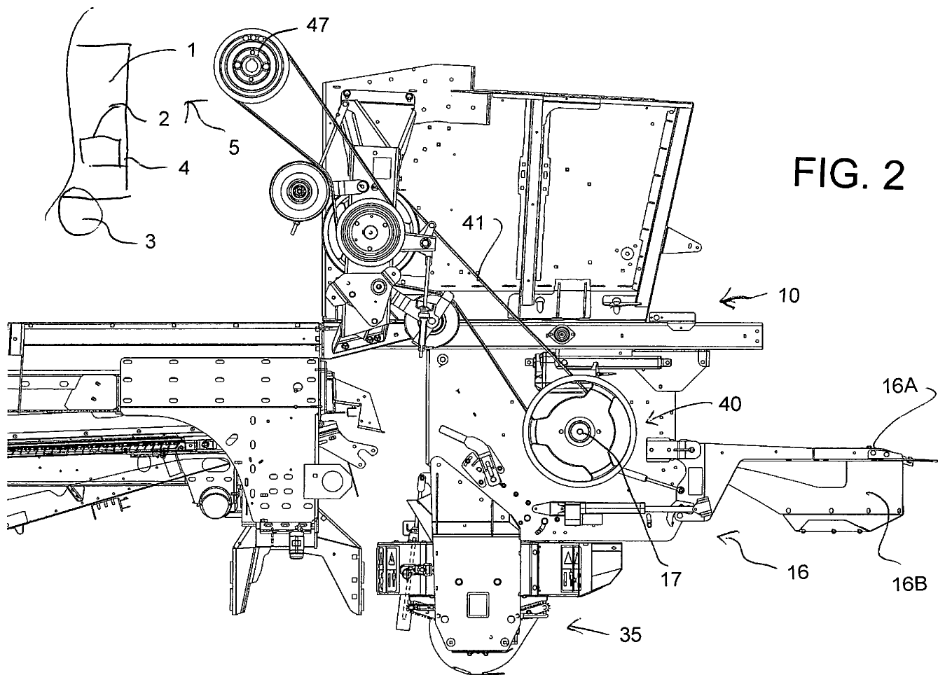

FIG. 3 is an isometric view from the rear and the other side of the combined apparatus including the straw chopper section and the weed seed destruction section of FIG. 1 but showing only the drive train and driven components with housing components removed.

FIG. 4 is a cross-section through a belt used conventionally to drive a component of a combine harvester such as particularly the straw chopper where only power for the chopper itself is required to be transmitted.

FIG. 5 is a cross-section through a belt of the present invention used to drive the straw chopper and seed destructor where power for both is required to be transmitted.

In the drawings like characters of reference indicate corresponding parts in the different figures.

### DETAILED DESCRIPTION

The combination of straw management system and weed seed destruction system is shown generally in for example U.S. Pat. No. 10,495,369 issued Dec. 3, 2019, the disclosure of which is incorporated herein by reference, to which reference may be made for further detail of features described only generally herein.

The apparatus herein is conventionally mounted on a combine harvester 1 carried on ground wheels 3 and including harvesting components of a conventional nature the rearmost one of which is the sieve 2 which discharges chaff and discarded seeds including weed seeds to the rear edge 4 of the sieve.

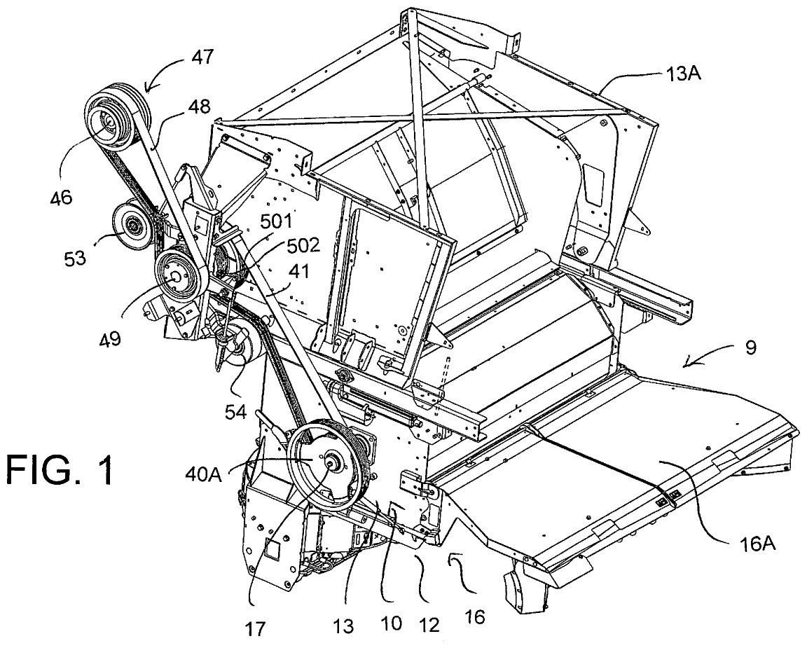

The combine harvester includes a chopper and discharge arrangement 9 shown in FIGS. 1 and 6 is basically as shown in U.S. Pat. No. 6,840,854 issued Jan. 11, 2005 of Redekop, the disclosure of which is incorporated herein by reference to which reference may be made for further detail of features described only generally herein. The chopper thus comprises a housing 10 defined by a top wall 11, a bottom wall 12 and two end walls 13. The end walls 13 include attachment means 13A for attachment of the housing to the outlet of a combine harvester for discharge of straw and optionally chaff from the combine harvester into an inlet opening 15 of the housing 10. The bottom wall 12 defines a semi-cylindrical portion extending from the inlet to an outlet through which chopped straw and air is discharged at relatively high velocity for spreading across the field or for transportation into a container.

Within the housing is mounted a hub 17 which is carried on suitable bearings for rotation about a hub axis at a center of the housing so that blade members 19 carried by the hub sweep around within the housing to entrap straw fed through the inlet and to carry the straw and air past stationary blades for chopping and for discharge through the outlet 16. The stationary blades are mounted on the housing at a position approximately midway between the inlet and the outlet so that the blade members 19 sweep between the stationary blades in a cutting action.

The above arrangement of straw chopper section is one example only of arrangements which can be used herein.

The chopper and spreading assembly 9 is arranged to be mounted at a rear straw discharge 5 of the combine harvester 1 and includes the housing 10, the rotor 17 mounted in the housing 10 for rotation around a generally horizontal axis and carrying the plurality of chopper blades 19 for chopping the discharge material.

At the exit 16 is provided the material spreading assembly which can be the form of a tailboard 16A with guide fins 16B for receiving the chopped material and spreading the material to the rear and sides of the combine harvester.

An apparatus 35 for destroying seeds comprises a body carried on a frame mounted at a suitable location on the combine harvester by mounting arrangements of a conventional arrangement. In the embodiment shown the destructor is mounted as a common unit on the frame of the chopper so as to be carried thereby on the hood at the straw exit. However these can be provided as separate units where for example the destructor is mounted at the rear axle and the chopper is mounted on the hood

The body provides two side by side housings 38, 39 each located adjacent a respected half of the discharge location the feed material containing separated chaff and discarded seeds separated by the combine harvester from harvested crop.

Each of the housings includes rotor and stator arranged to cause impacts on the weed seeds which devitalize the seeds as is well known.

A rotor is mounted in the housing for rotation about an upstanding axis at right angles to a bottom base of the housing. The rotor includes a cylindrical hub carrying blades. The individual blades of the set are spaced angularly.

Thus the rotor includes components thereon for engaging the feed material and for accelerating the feed material in a centrifugal direction away from the rotor.

In the housing around the rotor is provided a stator 48 which includes a series of surface elements for engaging the discarded seeds in the accelerated material and arranged such that the discarded seeds impact thereon and rebound therefrom back toward the rotor. Various designs of rotor and stator are known and can be used.

Thus the rotor and stator are arranged such that the discarded seeds rebound back and forth between the rotor and the stator to provide a plurality of impacts on the feed material to devitalize the seeds.

In a preferred arrangement, the seed destructor section 35 is integrated into the chopper 9 as a common unit with the chopper 9. In this arrangement the seed destruction section 35 acts two receive all residue from the sieves. The weed seeds are destroyed in the seed destructor and can be ejected into the chopper for spread with the straw residue on the tailboard 16A.

Thus the destruction section 36 and the chopper 9 form a common unit which can be supplied as a common assembly for attachment to the combine harvester. The common unit may include a common frame. The common unit can include a common drive arrangement by which a single output drive from the combine harvester is directed to the common unit and then directed by the drive mechanism to the chopper rotor and to the seed destruction section.

Thus the combined apparatus comprises the straw chopper 9 as described above together with the apparatus for destroying weed seeds as described above where the discharge opening of the housing is arranged such that the discharge opening can be directed to the side of the combine away from the straw chopper, towards the guide fins of the tailboard of the chopper, or into the housing of the straw chopper.

The housing of the chopper section 9 and the seed destructor section 35 are formed as a common or integral construction coupled together as single or common unit which can be mounted on the combine harvester at the rear of the combine so as to be associated with the rear straw discharge and the rear chaff discharge.

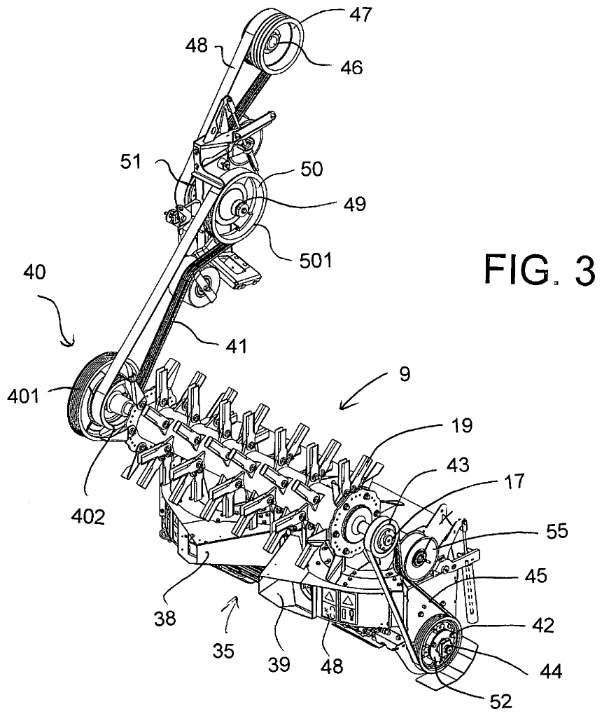

The chopper 9 has an input drive pulley 40 connected to the rotor 17 driven by a belt 41 from the combine. In the arrangement shown in FIG. 3, a pulley 43 of the chopper mounted on the opposite end of the shaft or hub 17 drives an input pulley 42 which communicates drive to an input shaft 44 of the seed destruction section 35 through the pulley 42 driven by a belt 45. In an arrangement (not shown) the pulleys 40 and 43 can also mounted at the same end of the hub 17. The drive to the chopper can be as shown where the output shaft 46 of the combine carries a pulley 47 which drives a belt 48 connected to a jack shaft 49 with pulleys 50 and 51 to drive the belt 41; but of course other drive arrangements can be used such as a shaft from an output gearbox.

The drive system includes at least one belt 41 or 48 or both which must carry the power for both the chopper and the destructor. In this embodiment both the belts 48 and 41 transfer the power to both components and must therefore be able to transfer the power requirements and provide the features discussed above.

While the arrangement shown herein is shown as an externally mounted chopper carried on the combine harvester at the rear straw discharge, some combines include an internal chopper mounted in the housing at a position in advance of the rear discharge. In this arrangement the seed destructor section can be located at the chaff discharge and arranged to direct material into the internal chopper or away from the internal chopper to the ground. In this case the internal chopper does not cooperate directly with a spreading system such as a tail board.

The rotational speed of the rotor of the seed destructor 35 can be adjustable to change the number of impacts a seed encounters during its passage.

When the system is arranged to bypass the destructor, a clutch 52 is operated to halt drive to the rotors of the weed seed destructor 35 from the input drive belt 45 and pulley 42.

The speed of the chopper rotor 17 is adjustable to slow and high speed by selecting larger and smaller pulley sections 401, 402 at the pulley 40 to receive the belt 41 and corresponding smaller and larger pulley sections 501, 502 at the pulley 50. The drive for the weed seed destruction section is driven from the slow-speed drive of the chopper. Therefore, the chopper can be selected to operate in low speed with the weed seed destruction section still operating. Therefore, either chopper speed can be selected without affecting the operation of the weed seed destruction section.

The belts 48, 41 and 45 are all tensioned by conventional idler rollers 53, 54 and 55 mounted on suitable tensioning systems as is well known.

In one arrangement (not shown) the drive belt 41 from the jack shaft 49 to the chopper rotor shaft 17 also acts to provide drive to the destructor input shaft 44. In the Figures as shown, an arrangement is provided where the belt 41 only drives the chopper rotor shaft 17 and the drive to the destructor rotor shaft 44 is proved by a separate belt 45 at the opposite end of the shaft 17. In both cases full power to both the chopper and the destructor is provided through the belts 41 and 48.

The arrangement described herein therefore provides a combine harvester 1 comprising the separation system 2 for separating from harvested crop a first material comprising straw and a second material comprising chaff. The combine harvester includes a mechanical drive output shaft 46 having an output pulley 47 thereon.

The straw management section for receiving the first material in this embodiment includes the chopper 9 and the tailboard 16A. However other arrangements can be used including an internal chopper and a driven disk type spreader.

The straw management section has the input drive shaft 17 with the input pulley 40 thereon and a mechanical drive transfer arrangement connects the input drive pulley 44 to the mechanical drive output pulley 47. The mechanical drive transfer arrangement includes the drive belt 41 which transfers the required power.

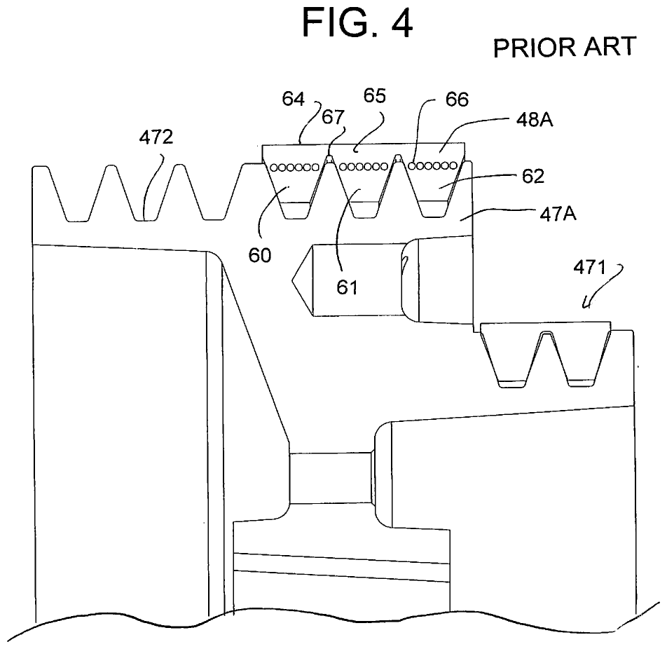

In FIG. 4 is shown the pulley 47A and drive belt 48A used in the conventional drive system. The pulley 47A is of the type conventionally provided on the drive shaft and is designed primarily to transfer power to the chopper. This includes across its width typically 3 longitudinally extending v-belt ribs 60, 61 and 62. In this arrangement the ribs are deep having a depth from the rear face of the belt of more than 0.5 inches. The belt also includes a base band 65 forming the rear face 64 and extending to the base 67 of the ribs which connects the ribs side by side.

As shown in FIG. 4, the cords 66 which provide the longitudinal strength and act to transfer the power through the belt are arranged within the ribs outward of the base 67 of the ribs so that the cords are associated with and located wholly in the ribs. For this reason, the cords are limited to the area within the ribs thus limiting the number of cords which can be used. As shown in FIG. 4 there are three ribs each containing six cords making a total of eighteen cords. The cords are also spaced from the rear face 64 by a distance greater than 0.2 inches and typically 0.25 inches.

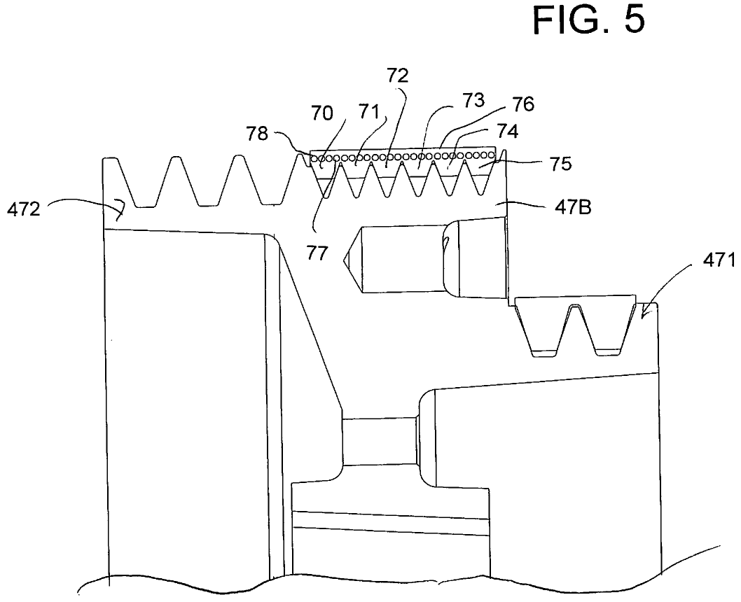

In FIG. 5 is shown a modified pulley and belt which are used to replace the original components in order to provide the ability to transfer the required increased power. In this embodiment the drive belt includes across its width and increased number (typically at least four, preferably at least five and in this embodiment six) of longitudinally extending v-belt ribs 70 to 75. These ribs are of reduced width so as to provide six ribs in the same width as the three ribs of FIG. 4. The ribs are also accordingly of a reduced depth so that they have a depth from the rear face of less than 0.5 inches and preferably less than 0.4 inches and preferably of the order of 0.35 inches.

The belt includes longitudinally extending reinforcing cord lengths 77 located again at spaced positions across the width of the belt. However in this embodiment all of the reinforcing cords are arranged in a single row across and within the base band 78 so that the. longitudinally extending reinforcing cords located are at uniformly spaced positions across the width of the belt. Thus the cords are closer to the rear face 76 and have a distance of a center of the cord from the rear face of the order of 0.1 inch. The cord lengths 77 can be formed from separate cords each forming one wrapping of turn along the belt. However more preferably the cord lengths form portions of a single cord wrapped helically and continually around the belt over the number of turns necessary to form the full number of cord lengths.

In the arrangement of the present invention, the combine harvester is modified to accommodate the high increased power required by the destructor section by removing the original output pulley shown in FIG. 4 from the output shaft and replacing the output pulley with a second output pulley 47B as shown in FIG. 5.

This is carried out without significantly increasing the width of the drive pulley 47A so that the belt 48 has a width of less than 3.0 inches and preferably less than 2.5 inches and preferably less than 2.3 inches.

Thus FIGS. 4 and 5 show cross sections from each style of belt. These two belts are used in the same place that is driven from the same output shaft. In view of the change in selection of the belt, the banded v-belt 48A has only 18 cords whereas the v-rib 48 has 24 cords. Therefore in theory the replacement belt will transmit 33% more power just based on tensile strength of the cords being equal. However the replacement belt is thinner so that it is more efficient and less energy lost in flexing. The replacement belt also has more rubber surface area to transmit the power from the cords to the rubber then to the belt's sheaves. Because the belt is thinner it can also run on smaller diameter sheaves or pulleys allowing a reduced weight of the pulley.

Thus due to these changes, the replacement belt can transmit up to 50% more power through a belt of the same width more efficiently and with less heat. This allows the drive system to be easily and quickly replaced so as to adapt the combine to accommodate the destructor system in combination with the straw management system by only changing the sheaves and belts.

The use of conventional belts requires a redesign of the whole drive system by widening structures, building heaver sheaves, adding wider idler pulleys, all while creating more overhung load which can act to overload bearings.

The pulleys 47A and its replacement 47B both include supplementary sheaves 471 and 472 which are associated with driving other components and are not related to the present invention and the improved belt of FIG. 5.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A combine harvester comprising:
a separation system for separating material from harvested crop including a first material comprising straw and a second material comprising chaff;
a mechanical drive output shaft having an output pulley thereon;
a weed seed destructor section for receiving at least some of the material from the separating device;
the weed seed destructor section having at least one input drive shaft having an input pulley thereon
a mechanical drive transfer arrangement connecting the input drive pulley to the mechanical drive output pulley;
the mechanical drive transfer arrangement including at least one continuous drive belt;
wherein said at least one continuous drive belt includes across its width a plurality of longitudinally extending v-belt ribs;
wherein said at least one continuous drive belt includes one or more cords forming longitudinally extending cord lengths which extend continuously along the continuous drive belt;
and wherein the longitudinally extending cord lengths are located at uniformly spaced positions across the width of the belt.

2. The combine harvester according to claim 1 wherein the v-belt ribs are integral at a base with a base band of the belt extending across the full width of the belt with each rib having two side walls converging from the base to a top wall spaced from the base band where all of the cord lengths are arranged in a single row across the base band.

3. A combine harvester comprising:
a separation system for separating material from harvested crop including a first material comprising straw and a second material comprising chaff;
a mechanical drive output shaft having an output pulley thereon;
a weed seed destructor section for receiving at least some of the material from the separating device;
the weed seed destructor section having at least one input drive shaft having an input pulley thereon
a mechanical drive transfer arrangement connecting the input drive pulley to the mechanical drive output pulley;
the mechanical drive transfer arrangement including at least one continuous drive belt;
wherein said at least one continuous drive belt includes across its width a plurality of longitudinally extending v-belt ribs;
wherein said at least one continuous drive belt includes one or more cords forming longitudinally extending cord lengths which extend continuously along the continuous drive belt;
wherein the v-belt ribs are integral at a base with a base band of the belt extending across the full width of the belt with each rib having two side walls converging from the base to a top wall spaced from the base band;
and wherein all of the cord lengths are arranged in a single row across the base band.

4. The combine harvester according to claim 1 wherein the cord lengths are formed from a single continuous cord wrapped a plurality times along the belt.

5. The combine harvester according to claim 1 further comprising a straw management section driven by said mechanical drive transfer arrangement wherein the straw management section includes at least one input drive shaft having a first input pulley thereon and the seed destructor section includes at least one input drive shaft having a second input pulley thereon and wherein the mechanical drive transfer arrangement connects the input drive pulley of the straw management section and/or the input drive pulley of the seed destructor section to the mechanical drive output pulley.

6. The combine harvester according to claim 5 wherein said seed destructor section comprises:
at least one destructor rotor housing arranged to receive the second material;
at least one destructor rotor arrangement for rotation about an axis and including rotor surfaces thereon for engaging the second material and for accelerating the second material;
a stator arrangement including a plurality of stator surfaces for engaging the weed seeds in the accelerated said second material to cause a plurality of impacts with the weed seeds;
the destructor rotor arrangement having an input drive member with an input pulley thereon;
wherein the mechanical drive transfer arrangement also connects the input drive pulley of the destructor rotor arrangement to the mechanical drive output pulley.

7. The combine harvester according to claim 6 wherein the input pulley of the weed seed destructor section is driven by a belt from the input drive shaft of the straw management section.

8. The combine harvester according to claim 7 wherein the mechanical drive transfer arrangement includes at least one drive belt arranged at a first side of the combine harvester and wherein the seed destructor section is driven by a second mechanical drive transfer arrangement on a second side of the combine harvester opposite the first side.

9. The combine harvester according to claim 8 wherein the straw management section includes a shaft to transfer drive from the first side to the second side.

10. The combine harvester according to claim 9 wherein the straw management section comprises a straw chopper and wherein the shaft to transfer drive from the first side to the second side drives a rotor of the straw chopper.

11. The combine harvester according to claim 4 wherein said at least one belt carries all of the power required to drive the straw management section and said weed seed destructor section.

12. The combine harvester according to claim 1 wherein the straw management section comprises a chopper with a chopper rotor mounted on and driven by said input drive shaft.

13. The combine harvester according to claim 1 wherein the belt has more than three v-belt ribs at spaced positions across its width.

14. The combine harvester according to claim 1 wherein the belt has more than four v-belt ribs at spaced positions across its width.

15. The combine harvester according to claim 1 wherein the belt has six v-belt ribs at spaced positions across its width.

16. The combine harvester according to claim 1 wherein the belt has a width of less than 3.0 inches and preferably less than 2.5 inches and preferably less than 2.3 inches.

17. The combine harvester according to claim 1 wherein the belt has a depth of less than 0.5 inches and preferably less than 0.4 inches and preferably of the order of 0.35 inches.

18. A method of driving components of a combine harvester where the combine harvester comprises:
a separation system for separating from harvested crop a first material comprising straw and a second material comprising chaff;
a mechanical drive output shaft;
a straw management section for receiving the first material;
the straw management section having at least one input drive shaft having an input pulley thereon;
the method comprising:
mounting on the combine harvester a weed seed destructor section arranged to receive the second material, said weed seed destructor section comprising:
at least one destructor rotor arrangement for rotation about an axis and including rotor surfaces thereon for engaging the second material and for accelerating the second material in a direction;
a stator arrangement mounted at a location along the direction and including a plurality of stator surfaces for engaging the weed seeds in the accelerated said second material to cause a plurality of impacts with the weed seeds;
the destructor rotor arrangement having an input drive member with an input pulley thereon;
providing on the combine harvester a mechanical drive transfer arrangement connecting the input drive pulley of the straw management section to the mechanical drive output pulley;
the mechanical drive transfer arrangement including at least one continuous drive belt;
providing an output pulley on the output shaft arranged for driving both the straw management section and the weed seed destructor section;
and providing a drive belt shaped to engage the output pulley which carries all of the power required to drive the weed seed destructor section and at least part of the straw management section;
wherein the continuous drive belt includes a plurality of longitudinally extending v-belt ribs;
wherein said at least one continuous drive belt includes one or more cords forming longitudinally extending cord lengths which extend continuously along the continuous drive belt;
wherein the longitudinally extending cord lengths are located at uniformly spaced positions across the width of the belt.

19. The method according to claim 18 wherein the v-belt ribs are integral at a base with a base band of the continuous drive belt extending across the full width of the continuous drive belt with each rib having two side walls converging from the base to a top wall spaced from the base band where all of the cord lengths are arranged in a single row across the base band.

20. The method according to claim 18 wherein an initial output pulley is removed from the output shaft and replaced with said output pulley which has a width not significantly greater than the initial output pulley on the output shaft.

21. The method according to claim 18 wherein the input pulley of the weed destructor section is driven by a belt from a pulley at an end of the input drive shaft of the straw management section opposite to said input drive pulley thereof.

22. A combine harvester comprising:
a separation system for separating material from harvested crop including a first material comprising straw and a second material comprising chaff;
a mechanical drive output shaft having an output pulley thereon;
a straw management section for receiving the first material;
a seed destructor section for receiving the second material;
a first mechanical drive transfer arrangement connecting the mechanical drive output pulley to the straw management section to provide drive thereto;
the mechanical drive transfer arrangement including at least one drive belt arranged at a first side of the combine harvester;
wherein the seed destructor section is driven by a second mechanical drive transfer arrangement on a second side of the combine harvester opposite the first side.

23. The combine harvester according to claim 22 wherein the straw management section includes a shaft to transfer drive from the first side to the second side.

24. The combine harvester according to claim 23 wherein the straw management section comprises a straw chopper and wherein the shaft to transfer drive from the first side to the second side drives a rotor of the straw chopper.
